(19) United States
(12) Patent Application Publication
(10) Pub. No.: US 2023/0270056 A1
(43) Pub. Date: Aug. 31, 2023

(54) METHOD OF COMBINED CRACKING TORNADO AND A DEVICE OF COMBINED CRACKING TORNADO

(71) Applicant: Liping JIANG, Xiamen City (CN)

(72) Inventor: Liping JIANG, Xiamen City (CN)

(21) Appl. No.: 18/154,478

(22) Filed: Jan. 13, 2023

(30) Foreign Application Priority Data
Jan. 14, 2022 (CN) 202210058543.3

(51) Int. Cl. A01G 15/00

(52) U.S. Cl. CPC A01G 15/00

(57) ABSTRACT

The invention is providing a method of the combined cracking tornado and a device of the combined cracking tornado. They include: A is providing a specially heavy-duty carrier; B is providing a spoiler, and the spoiler is loaded on the specially heavy-duty carrier; C is providing a release device, and the release device is set on the specially heavy-duty carrier. When the specially heavy-duty carrier is moved to the tornado wind eye, the release device release the spoiler; D is providing the spray device. The spray device is set on the specially heavy-duty carrier. The spray device is moved to the edge of the tornado wind eye. The spray device can spray the spoiler along the reverse direction of the tornado vortex. Then the spoiler can hedge, consume and weaken the cyclonic momentum of the tornado and crack the tornado.

### FIELD OF THE INVENTION

The present invention relates to the field of the prevention of the tornado disaster. In particular to a method of the combined cracking tornado and a device of the combined cracking tornado.

### BACKGROUND OF THE INVENTION

The tornado is a serious meteorological disaster. Once the tornado occurs, it will cause a large number of casualties and great property damage. The tornado is formed by the rapid spinning airflow which can cause upright hollow tube. The phenomenon is mostly occurring in the unstable air masses of the high temperature and high humidity environment. The unstable air masses is due to the temperature difference between the ground and the high altitude, which can make the cold air sharply fall and the hot air rapidly rise. Which will form a strong wind vortex with a high-speed rotating funnel-shaped cloud column. The strong wind vortex products by the strong air convection between the upper and lower layers of the air.

The tornado is a rarely severe air convection and has the locality, small-scale and suddenness. The severe and small-scale air vortex is formed by the intense air convective during strongly unstable weather conditions. For example, there were some storms of the lasts 4 days outbreaking in American South in 2011. The World Meteorological Organization recorded 207 different tornadoes in a 24-hour period on Apr. 27, 2011. This tornado caused more than 300 people dead and about $11 billion damages.

The tornado has large or small tornado, but their shapes are generally funnel-shaped with a large top and a small bottom. The Conditions of the tornadoes forming include the near-surface wind shear, vertical motion and unstable energy. The structure of the tornadoes consists of the main body (funnel cloud) and the convective system (maintaining funnel cloud's existence). For example, the cumulonimbus cloud that brights by the thunderstorm includes three parts: the bottom of which is the eye of the tornado, the middle of which is a negative pressure zone, and around of which has largest rotating wind speed (150 km/h) and larger destructive power.

So far, for a serious meteorological disaster of the tornado, there is almost no way to weakening and cracking tornadoes effectively. Generally, people build basement under the building in the tornado-prone areas. Once the tornado occurs, the people will run in the basement. After the tornado leaves, the people run out from the basement. Although this can reduce people dead, but can not avoid property damage. This is a passive defense measures.

### SUMMARY OF THE INVENTION

In order to overcome the technology problems the cracking tornado, the present invention provides a method of combined cracking tornado and a device of combined cracking tornado.

According to the first aspect of the present invention embodiment, we provide a method of the combined cracking tornadoes. It includes: A part is providing a specially heavy-duty carrier; B part is providing a spoiler, which is loaded on the special heavy-duty carrier; C part is providing a release device, which is set on the specially heavy-duty carrier. When the specially heavy-duty carrier is moved to the tornado wind eye, the release device releases the spoiler, and the spoiler can be blocked at the bottom of the tornado wind eye to form a blockage body. Then the blockage body can block the tornado wind eye until completely blocking. The tornado is broken; D part is providing a spraying device. The spraying device is set on the special heavy-duty carrier. When the special heavy-duty carrier is moved to the edge of the tornado eye, the spraying device sprays the spoiler along the reverse direction of the tornado vortex. The method can achieve offset, consuming and weakening for the tornado.

For this embodiment, the spoiler comprises lightweight material products. The release device releases the spoiler, and the spoiler can form lightweight blockage body.

For this embodiment, the spoiler comprises liquid. The spraying device can spray the liquid along the reverse direction of the tornado vortex. The momentum of the liquid offsets with the momentum of the tornado cyclone. Then the tornado is broken.

For this embodiment, the spoiler comprises a plurality of balloons. The balloons are pre-assembled in the special heavy-duty carrier. The balloons are attached to the special heavy-duty carrier. The release device releases the balloons. The balloons expand rapidly under a state of negative pressure inside the tornado wind eye. Then the expanded balloons form balloon blockage body.

For this embodiment, a method of the combined cracking tornadoes also includes: E is providing the spray adhesive; F is providing the dispensing device of the fog gun. The dispensing device of the fog gun is set on the special heavy-duty carrier. The spray adhesive is pre-installed in the dispensing device of the fog gun; G is providing the dispensing device of the fog gun, and the dispensing device of the fog gun can spray the spray adhesive onto the balloon. Then a balloon and another balloon are bond each other.

For this embodiment, a method of the combined cracking tornadoes also includes: H is providing the light weight interstitial material. The light weight interstitial material is pre-installed within the dispensing device of the fog gun. The dispensing device of the fog gun is used to fill the gap of the adjacent balloons.

For this embodiment, the spoiler is the tarpaulin. The tarpaulin is pre-installed within the release device; the release device can open or close the tarpaulin. When the tarpaulin is opened, the outer diameter of the tarpaulin is greater than the outer diameter of the tornado wind eye.

According to the second aspect of the present invention embodiment, we provide a device of the combined cracking tornadoes. It is suitable for the method of the combined cracking tornadoes. It includes: the specially heavy-duty carrier, and the spoiler is loaded on the special heavy-duty carrier; the release device, and the release device is set on the special heavy-duty carrier. The release device can release the spoiler. The spraying device, and the spraying device is set on the specially heavy-duty carrier. The spraying device can spray the spoiler.

For this embodiment, a device of the combined cracking tornadoes also includes: the dispensing device of the fog gun. The dispensing device of the fog gun is set on the special heavy-duty carrier.

For this embodiment, the release device includes the expansion installation. The expansion installation is set on the release device. The expansion installation has the expansion arm. The expansion arm can stretch and contract around the expansion installation. After the expansion arm stretching, the outer diameter of the expansion arm is greater than the outer diameter of the tornado wind eye.

For this embodiment, the release device includes the expansion installation and/or the folded installation. The expansion installation is set on the release device. The expansion installation has the expansion arm. The expansion arm can stretch and contract around the expansion installation. After the expansion arm stretching, the outer diameter of the expansion arm is greater than the outer diameter of the tornado wind eye. The folded installation is set on the release device. The folded installation includes the folded skeleton. The folded skeleton can stretch and contract. After the folded skeleton stretching, the outer diameter of the folded skeleton is greater than the outer diameter of the tornado wind eye.

The present invention can provide the beneficial effects, as follows:

The present invention can provide the special heavy-duty carrier, the spoiler, the release device and the spraying device. The release device and the spraying device are fixed and pulled by the special heavy-duty carrier, so that they can not be affected by the tornado. The spoiler is loaded by the special heavy-duty carrier. The spoiler is released at the bottom of the tornado wind eye by the release device. Then the spoiler can form the blockage body. The blockage body can block the tornado wind eye and block the rising air that caused by the unstable energy in the atmosphere of the convection system. This can make the tornado lost negative pressure. The spraying device can spray the spoiler along the reverse direction of the tornado vortex. The momentum of the spoiler can offset the cyclone momentum of the tornado and consume and weaken the cyclone momentum of the tornado. It can effectively weaken and crack the tornado to avoid the weather disasters of the tornado-induced. It can protect personal safety and property security.

It should be understood that the above description and the later detailed descriptions only are exemplary and explanatory. It can not limit the present disclosure.

### BRIEF DESCRIPTION OF THE DRAWINGS

The accompanying drawings are incorporated into the brief description and form a part of the specification. They can illustrate the embodiments. They are used to explain the principles of the present disclosure.

FIG. 1 is the schematic diagram of the plan layout about a method of the combined cracking tornado.

FIG. 2 is the partial schematic diagram of the local layout about a method of the combined cracking tornado.

FIG. 3 is the schematic diagram of the local layout about a method of the combined cracking tornado.

FIG. 4 is the schematic diagram of the release device.

FIG. 5 is the schematic diagram of the spraying device.

### DESCRIPTION OF THE ATTACHED MARKERS

1: the specially heavy-duty carrier; 11: the specially heavy-duty carrier of the balloons: 12: the specially heavy-duty carrier of the water; 13: the specially heavy-duty carrier of the spray adhesive; 14: the specially heavy-duty carrier of the interstitial material; 2: spoiler; 21: the balloons; 22: the tarpaulin; 23: the light weight interstitial material; 3: the release device; 31: the folded installation; 311: the folded skeleton; 4: the spraying device; 41: nozzles; 42: the stretching structure; 5: the tornadoes.

### DETAILED DESCRIPTION OF THE EMBODIMENTS

The exemplary embodiments will be detailly described in this section and the accompanying drawings. When the following description relates to the accompanying drawings, unless otherwise indicated, the same numerals in different accompanying drawings indicate the same or similar elements. The embodiments can not represent all embodiments that are consistent with the present disclosure. Conversely, they are only examples of the devices and methods that are consistent with some aspects of the present disclosure, as the appended claims detailed in the appended claims.

The tornado is a concentratedly released form about the unstable energy in a very small area of the nearby ground. The tornado is considered to be related to updrafts and vertical wind shear in the dynamics level. It can be roughly divided into four stages: 1. The convective system can bring the unstable energy in the atmosphere. And the convective system can trigger updrafts. 2. The updrafts can form the vertical vorticity under the action of the wind speed and wind shear. They can begin to rotate in the horizontal direction. 3. The rotary system develops inside the convective system under the action of the converging airflow. And the rotary system can form the tornado core in the troposphere. 4. Under the action of the sinking airflow in front of the convective system, the tornado vortex developed by the tornado core can extend to the lower cushion. The ground pressure drops sharply, and the ground wind speed rises sharply. Finally the tornado is formed.

According to the generation mechanism of the tornado and the development and decay conditions of the tornado growth, the tornado can be weakened and cracked. About the comparation of the tornado and the hurricanes, the energy of tornado is not large. The shape of tornado is generally funnel-shaped. The diameter of tornado near the ground is very small. It usually is 25 m-100 m. Sometime it can reach 1 km. According to the law of the vortex instability, the bottom of the funnel-shaped tornado is the tornado wind eye. When the tornado wind eye is blocked, the tornado will lose the negative pressure. It can block the rising air that caused by the unstable energy in the atmosphere of the convection system. Then the tornado can be broken. Because the tornado is a high-speed rotaty funnel-shaped vortex cyclone, it can be hedged by its cyclonic momentum. This can achieve to weaken and break the tornado.

Thus, this disclosed embodiment provides a method of combined cracking tornado and a device of combined cracking tornado. They can solve the relevant technical problems. They can weaken and crack the meteorological disaster of the tornado. This can protect personal safety and property security.

### Example of Implementation

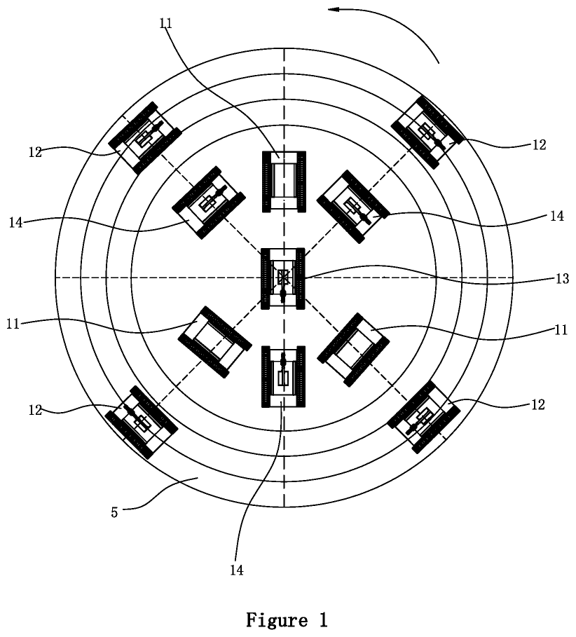

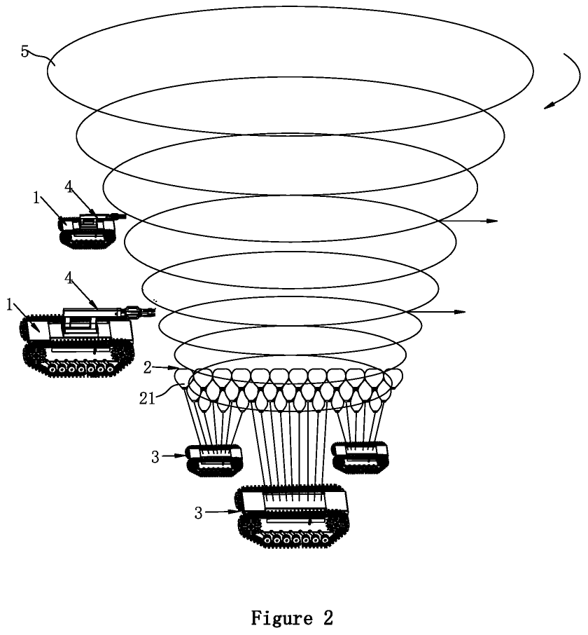

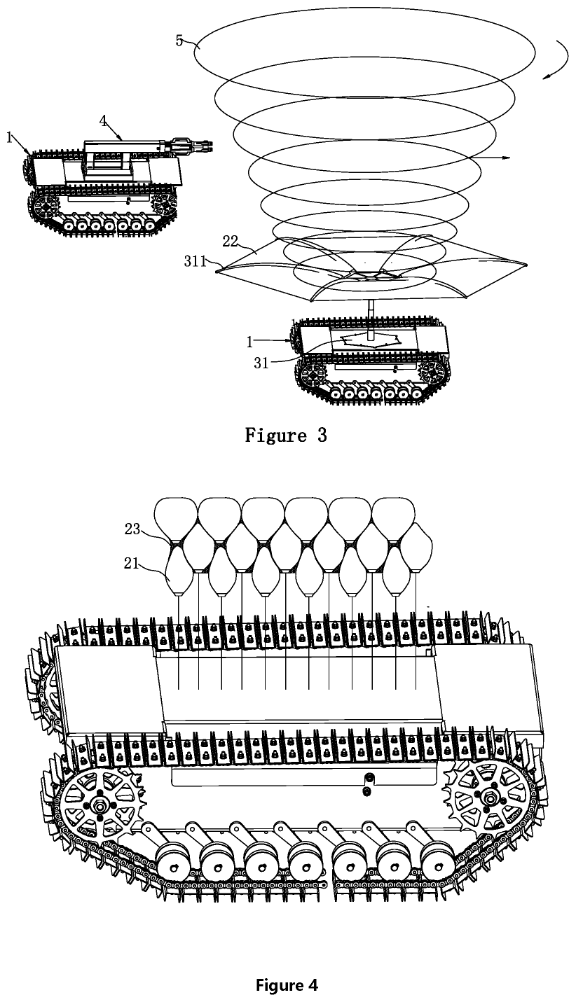

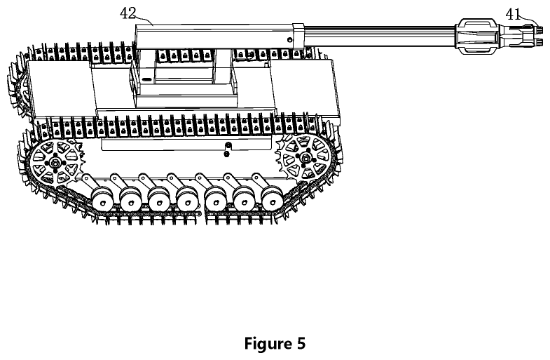

FIG. 1 is the schematic diagram of the plan layout about a method of the combined cracking tornado. FIG. 2 is the partial schematic diagram of the local layout about a method of the combined cracking tornado. FIG. 3 is the schematic diagram of the local layout about a method of the combined cracking tornado. FIG. 4 is the schematic diagram of the release device. FIG. 5 is the schematic diagram of the spraying device.

As the FIG. 1 to the FIG. 5 shown, this invention provides a method of the combined cracking tornado. It includes: A is providing the specially heavy-duty carrier 1; B is providing the spoiler 2, and the spoiler 2 is set on the specially heavy-duty carrier 1; C is providing a release device 3, and the release device 3 is set on the specially heavy-duty carrier 1. When the specially heavy-duty carrier 1 is moved to the tornado wind eye 5, the release device 3 release the spoiler 2. The spoiler 2 can form the blockage body at the bottom of the tornado 5 wind eye. The blockage body can block the tornado 5 wind eye. Then the blockage body cracks the tornado 5; D is provide the spraying device 4. The spraying device 4 is set on the specially heavy-duty carrier 1. When the specially heavy-duty carrier 1 is moved to the edge of the tornado 5 wind eye, the specially heavy-duty carrier 1 is the opposite direction with the vortex direction of the tornado 5. And the spraying device 4 can spray the spoiler 2 along the reverse vortex direction of the tornado 5. It can hedge, consume, and weaken the cyclonic momentum of the tornado 5 to crack the tornado 5.

The specially heavy-duty carrier 1 includes a self-reliant vehicle that is protected from the tornado 5. For example, the heavy tank vehicle, the heavy armored vehicle, etc. The spoiler 2 is loaded on the specially heavy-duty carrier 1. And the release device 3 and the spraying device 4 are set on the specially heavy-duty carrier 1, respectively. At the early stage of the tornado 5 or during the tornado 5 occurs, by the manned or unmanned driving, the specially heavy-duty carrier 1 is driven to the edge of the tornado wind eye. At this time, the release device 3 can release the spoiler 2. The spraying device can spray the spoiler 2 along the reverse direction of the tornado 5 vortex. For example, the specially heavy-duty carrier 1 can be equipped with the expansion installation. The expansion installation can move the spraying device 4 to the edge of the tornado 5 wind eye by the telescopic function of the expansion installation. The present embodiment is providing two types of specially heavy-duty carrier 1. They load the release device 3 and the spraying device 4, respectively.

When the tornado 5 occurs, the specially heavy-duty carrier 1 loaded the release device 3 is moved to the tornado 5 wind eye. And the specially heavy-duty carrier 1 can release the spoiler 2. After the release device 3 releases the spoiler 2, the spoiler 2 can form the blockage body at the bottom of the tornado 5 wind eye. Due to the tornado 5 is movable, the specially heavy-duty carrier 1 loaded the release device 3 can move with the movement of the tornado 5 wind eye by manned or unmanned means. This can ensure that the blockage body of the spoiler 2 is always at the bottom of the tornado 5 wind eye. The blockage body of the spoiler 2 can block the tornado 5 wind eye. It can block the updrafts caused by the unstable energy in the atmosphere of the convection system. Then it can achieve to crack the tornado 5.

At the same time, the specially heavy-duty carrier 1 loaded the spraying device 4 can move to the edge of the tornado 5 wind eye and against the direction of the tornado 5 vortex. The spraying direction of the spraying device 4 is opposite with the direction of the tornado 5 vortex. The spraying device 4 spray the spoiler 2 along the opposite direction of the tornado 5 vortex. The spoiler 2 can product the momentum. The momentum of the spoiler 2 can offset with the cyclonic momentum of the tornado 5. And it can consume and weaken the cyclonic momentum of the tornado 5. The blockage body of the spoiler 2 can achieve to crack the tornado 5 effectively and completely.

In this disclosed embodiment, the spoiler 2 includes a lightweight material product, which is loaded on the special heavy-duty carrier 1 loaded the release device 3. And the release device 3 can release the spoiler 2. When the release device 3 release the spoiler 2, the lightweight blockage body can be formed at the bottom of the tornado 5 wind eye. The lightweight blockage body can be attracted upward based on the negative pressure inside the tornado 5. And the lightweight blockage body is adsorbed at the bottom of the tornado 5 wind eye. The light plugging body can be attracted upward based on the negative pressure inside the tornado 5. The lightweight blockage body can achieve to block the tornado 5 wind eye. The spoiler 2 includes liquid. The liquid is loaded on the specially heavy-duty carrier 1. And the spraying device 4 can spray the liquid. It can achieve to hedge, consume and weaken the cyclonic momentum of tornado 5.

The lightweight material product of the spoiler 2 includes a plurality of balloons 21. The balloons 21 are pre-assembled in the special heavy-duty carrier 1. The balloons 21 is towed on the release device 3 of the special heavy-duty carrier 1. The release balloons 21 can protect from the effect of the tornado 5. The release balloons 21 can stay at the bottom of the tornado 5 wind eye. In this disclosed embodiment, the balloons 21 is ultra-thin and has high strength, high elasticity and uniform thickness. The large number of ultra-thin and different sizes balloons 21 can form a string network. Due to the center zone of the tornado 5 wind eye is a negative pressure zone, after the release device 3 release the balloons 21, the balloons 21 immediately expanded and connected into a group. The balloons 21 quickly formed a balloon 21 blockage body. Because the balloons 21 is towed by the special heavy carrier 1 containing the release device 3 and they can form a series of beam network. The balloon 21 blockage body quickly expanded and always agglomerate. And it can float in the center of the tornado 5 wind eye. And it can fill the bottom of the tornado 5 wind eye. It can block the funnel throat aperture parts of the tornado 5 wind eye. And it can block the updrafts caused by the unstable energy in the atmosphere of the convection system. In this disclosed embodiment, the special heavy-duty carrier 1 has the rope. The rope can connect the balloons 21 and the release device 3 of the special heavy carrier 1. The rope is high strength tope. When the tornado 5 occur, this rope can achieve the balloon 21 blockage body pull and tract.

The balloons 21 includes the heterotypic balloon 21. For example, the balloons 21 can be the round balloons 21, the oval balloons 21, the convex balloons 21 and other irregularly shaped balloons 21. There is a gap between the round balloons 21 and the oval balloons 21. The convex balloons 21 can be placed between the round balloons 21 and the oval balloons 21. The convex balloons 21 can fill the gap. The convex balloons 21 can be equivalent to the spray adhesive. When the heterotypic balloons 21 expand and form the balloons 21 blockage body, it can reduce the gap during adjacent balloons 21 and increase the denseness of the balloons 21 blockage body. It can increase the effectiveness of the balloons 21 blockage body plugging the tornado 5 wind eye.

The method of combined cracking tornado 5 also includes: E is providing the spray adhesive; F is providing the dispensing device of the fog gun. The dispensing device of the fog gun is set on the special heavy-duty carrier 1. The spray adhesive is pre-installed in the dispensing device of the fog gun; G is providing the dispensing device of the fog gun. The dispensing device of the fog gun can spray the spray adhesive to the balloons 21. And the spray adhesive can bond the adjacent balloons 21. The spray adhesive has viscosity. For example, the spray adhesive can be water glue. The release device 3 can release the balloons 21. The dispensing device of the fog gun can spray glue. The glue can be attached to the surface of the balloons 21. The glue can bond the adjacent balloons 21. It can increase the strength of the balloons 21 blockage body. When the release device 3 uninterrupted release the balloons 21, the adhesive effect of the glue can make the diameter of the gas blockage body nore and more increasing. And eventually it can be expanded into more than the diameter of the bottom of the tornado 5 wind eye. The balloons 21 blockage body can achieve to block the tornado 5 wind eye.

In this disclosed embodiment, in order to increase the spraying area of the spray adhesive and the balloons 21, the spray adhesive can be sprayed outward in the form of foggy existence by the dispensing device of the fog gun. After the balloons 21 are released by the release device 3, the adjacent balloons 21 can be collided and adhered. The same balloon 21 can be adhered to a number of balloons 21 at the same time. This can relatively reduce the formation time of balloon 21 blockage body and increase the strength of balloon 21 blockage body. It can achieve more effective and more rapid cracking tornado 5.

The balloons 21 have the certain expansion volume. When the multiple balloons 21 stick together, the adjacent balloons 21 have a certain gap between them. Through providing the heterotypic balloons 21, the gap can be reduced. But the relative filling is less adequate. Thus, the method of combined cracking tornado 5 also includes: H is providing the light weight interstitial material 23. The light weight interstitial material 23 is pre-installed in the dispensing device of the fog gun. The light weight interstitial material 23 is used to fill the gap between the adjacent balloons 21. The light weight interstitial material 23 may be the granular light weight foamed plastic. The granular light weight foamed plastic may be sprayed out by the dispensing device of the fog gun. And the granular light weight foamed plastic can form the foggy. It can increase the contact area between the gaps of the adjacent balloons 21 and the granular light weight foamed plastic. This can improve the filling effectiveness of the granular light weight foamed plastic in the gaps of the adjacent balloons 21.

In the negative pressure zone of the tornado wind eye center, when the release device 3 release the balloons 21, the balloons 21 string network can rapidly expand by the high-strength rope traction. The dispensing device of the fog gun can spray fog water glue to the balloons 21. The adjacent balloons 21 can quickly adhere, agglomerate and expand. The dispensing device of the fog gun can spray the granular light weight foamed plastic to fill the gap of the adjacent balloons 21. This can form the blockage body of the dense gas. The blockage body can float in the center of the tornado 5 wind eye. With the increasing number of balloons 21, the diameter of the gas blockage body gradually increases. The pipe airflow of the tornado 5 wind eye is not smooth. And it can gradually fill the bottom of the tornado 5 wind eye. Eventually it can exceed the diameter of the bottom of the tornado 5 wind eye. And it can form the agglomeration isolation layer of the light weight material. This can achieve to block the tornado 5 wind eye and crack the tornado 5.

During the formation of the balloons 21 blockage body, the dispensing device of the fog gun can also spray the light weight material products, such as silk fabric. The silk fabric can be bonded to the balloons 21 under the bonding action of the water glue. It can increase the blockage area of the balloons 21 blockage body and the denseness of the balloons 21 blockage body. This can improve the effectiveness of the balloons 21 blockage body in the tornado 5 wind eye.

Because the diameter of the tornado 5 near the ground is very small, the diameter usually is 25-100 meters. Sometime it can reach 1 km. The spoiler 2 of the light weight material products can also be the tarpaulin 22. The release device 3 can be the device with stretch function. The tarpaulin 22 is set on the release device 3. The release device 3 can open or close the tarpaulin 22. When the tarpaulin 22 opens, the outer diameter of the tarpaulin 22 is larger than the outer diameter of the tornado 5 wind eye. It can form the isolation layer of the light weight tarpaulin 22. It can achieve to block the tornado 5 wind eye and crack the tornado 5.

The specially heavy-duty carrier 1 loaded the release device 3 moves to the tornado 5 wind eye. The release device 3 release the spoiler 2 to the bottom of the tornado 5 wind eye. The spoiler 2 can form the blockage body. It can block the tornado 5 wind eye. This can achieve to crack the tornado 5. Based on the skin effect of the tornado 5, the surroundings of the tornado 5 has the strong cyclonic flow and the strong cyclonic momentum. The middle of the tornado is the cavernous negative pressure zone. The specially heavy-duty carrier 1 loaded the spraying device 4 moves to the edge of the tornado 5 wind eye. The spraying device 4 sprays the spoiler 2 along the reverse direction of the tornado 5 vortex. The momentum of the spoiler 2 can hedge, consume, weaken the cyclonic momentum of the tornado 5. It can achieve to break the tornado 5.

In this disclosure embodiment, the spoiler 2 includes the liquid. The liquid may be water. The specially heavy-duty carrier 1 containing the spraying device 4 can load a certain amount of water liquid. The specially heavy-duty carrier 1 containing the spraying device 4 can be the modified heavy fire truck. The spraying device 4 of the modified heavy fire truck can be the spray water gun. The spray water gun can provide the high speed water liquid. For example, the spray water gun can be the high-pressure and high-speed spray water gun. The specially heavy-duty carrier 1 is modified to the heavy-duty fire truck and the spray water gun. At the early stage of the tornado 5 or during the tornado 5 occurs, the modified heavy fire truck can be moved to the edge of the tornado 5 wind eye. Through adjusting the spray direction of the spray water gun, the spray direction of the spray water gun is opposite with the direction of the tornado 5 vortex. This can spray out of the water liquid along the tangential direction of the tornado 5 vortex. The water liquid can effectively contact with the tornado 5. The spray water liquid has the momentum. The momentum of the water liquid is equal to the product of the mass of the water liquid and the speed of the water liquid. The spray water gun can spray the water liquid by the high pressure of the spray water gun. The speed of the water liquid is large enough. The specific gravity of the water liquid is much larger than the specific gravity of air. The momentum of the water liquid can offset, consume and weaken the cyclonic momentum of the tornado 5. The blockage body of the spoiler 2 can block the tornado 5 wind eye. Finally, it can achieve to break the tornado 5.

In this disclosed embodiment, the nozzle 41 of the spray water gun can be the shower type. It can spray the water liquid by the high speed. And it can increase the contact area of the water liquid and the tornado 5 vortex gas. The momentum of the water liquid can effectively offset the cyclonic momentum of the tornado 5 vortex gas. It can hedge, consume and weaken the cyclonic momentum. Through hedging and offsetting the cyclonic momentum of the tornado 5, it can achieve to break the tornado 5.

In order to increasing the liquid momentum of the spray water gun spraying, the water liquid can contain a certain amount of industrial salt and other adulterants. The specific gravity of the industrial salt is greater than the specific gravity of water. Under the same conditions of the spray speed, a way that increasing the mass can increase its momentum. And it can effectively improve the hedging, consumption and weakening of the cyclone momentum. It can quickly achieve to crack the tornado 5 and effectively reduce or avoid the occurrence of the tornado 5 disaster. It is understood that the type of the liquid spoiler 2 is not limited to this.

In the present disclosure embodiment, the number of the specially heavy-duty carrier 1, the number of the spoiler 2, the number of the release device 3 and the number of the spraying device 4 can not be specifically limited, separately. It can achieve to crack the tornado 5. For example, when the tornado 5 is cracked, the specially heavy-duty carrier 1 can load a sufficient number of spoiler 2. The number of spoiler 2 is based on the size of the tornado 5 wind eye. The spoiler 2 can form the blockage body of the spoiler 2 to block the tornado 5 wind eye. Four specially heavy-duty carriers 1 load the spraying devices 4. They can be provided to crack the tornado 5. These spraying devices 4 of the specially heavy-duty carriers 1 are symmetrically and equally spaced in the center of the tornado 5 wind eye. Through increasing the number of the spraying devices 4 of the specially heavy-duty carriers 1 and increasing the momentum of the spoiler 2, the cyclonic momentum of the tornado 5 can be effectively hedged, consumed and weakened step by step. It can improve the success rate and efficiency to break the tornado 5.

For example, the specially heavy-duty carrier 1 carrying the balloons 21 and the release device 3 of the releasing balloons may be called the specially heavy-duty carrier of the balloons 11. The specially heavy-duty carrier 1 carrying the water liquid and the spraying device 4 of releasing the water liquid may be called the specially heavy-duty carrier of the water 12. The specially heavy-duty carrier 1 carrying the spray adhesive and the dispensing device of the fog gun for spraying the spray adhesive may be called the specially heavy-duty carrier of the spray adhesive 13. The specially heavy-duty carrier 1 carrying the light weight interstitial material 23 and the dispensing device of the fog gun for spraying the light weight interstitial material 23 may be called the specially heavy-duty carrier of the interstitial material 14. Now there are three specially heavy-duty carriers of the balloons 11, four specially heavy-duty carriers of the water 12, one specially heavy-duty carrier of the spray adhesive 13 and three specially heavy-duty carriers of the interstitial material 14 being provided. They are arranged to crack the tornado 5, respectively, according to the layout of the FIG. 2.

Based on the same idea, the present disclosure embodiment also provides the device of combined cracking tornado. The device of combined cracking tornado is used to implement the method of combined cracking tornado. The device of combined cracking tornado includes: the specially heavy-duty carrier 1, the release device 3 and the spraying device 4. The spoiler 2 can be installed on the specially heavy-duty carrier 1. The release device 3 and the spraying device 4 are set on the specially heavy-duty carrier 1, respectively. They can be used to release and spray the spoiler 2, respectively. When the spoiler 2 is the balloons 21, the specially heavy-duty carrier 1 can be modified to the heavy-duty tank vehicle. A large number of balloons 21 can be loaded on the modified heavy tank vehicle. The balloons 21 can be towed on the modified heavy tank vehicle by the high-strength ropes. A large number of balloons 21 can form the string beam network. The release device 3 can be the opening door structure. The opening door structure is set on the roof of the modified heavy tank vehicle. When the modified heavy tank vehicle is moved to the tornado 5 wind eye, the opening door structure can open the roof of the modified heavy tank vehicle. The balloons 21 of the string network are released to the negative pressure zone of the center of the tornado 5 wind eye.

The release device 3 may also include: the expansion installation. The expansion installation is set on the release device 3. The expansion installation has the expansion arm. The expansion arm may be extended and contracted around the expansion installation. After the expansion arm is extended, the outer aperture threshold of the expansion arm is greater than the outer aperture of the tornado 5 wind eye. For example, when the spoiler 2 is balloons 21, the outer aperture of the expansion arm may be smaller than the outer aperture of the tornado 5 wind eye. It can ensure that the balloons 21 released by the release device 3 can be directed into the negative pressure zone of the center of the tornado 5 wind eye. For example, the number of the expansion arm may be six. The expansion arm can be symmetrically set. The outer aperture of these expansion arms is smaller than the outer diameter of the tornado 5 wind eye. These expansion arms can form the channel. The gap of the adjacent expansion arms is smaller than the size of the balloon 21. It can avoid the balloon 21 through the gap of the adjacent expansion arms. After the balloons 21 are released, they can move upward in the channel. This can ensure that the balloons 21 are directed into the negative pressure zone in the center of the tornado 5 wind eye.

The spoiler 2 is the tarpaulin 22. The tarpaulin 22 is set on the expansion arm. After the expansion arm is extended, the outer diameter of the tarpaulin 22 is larger than the outer diameter of the tornado 5 wind eye. For example, the tarpaulin 22 can be hooked on the expansion arm by hanging buckle. Based on the expansion of the expansion arm, it can realize the expansion and retraction of the tarpaulin 22. After the expansion arm is extended, the tarpaulin 22 can form the blockage layer and isolation layer at the bottom of the tornado 5 wind eye. This can destroy the vortex mechanism of the tornado 5. The expansion arm can be expand and retract by the hydraulically telescopic operation or the pneumatically telescopic operation.

After the expansion arm is extended, the expansion arm can be fixed on the ground or the expansion arm has a certain self-weight. This can avoid the expansion arm and the tarpaulin 22 to be affected by the tornado 5. For example, the fixed frame may be set in the middle of the expansion arm or at the end away from the specially heavy-duty carrier 1. The fixed frame may reach to the ground and be fixed to the ground. For example, the fixed frame can be attached to another specially heavy-duty carrier 1. The expansion arm can be fixed by the specially heavy-duty carrier. The tarpaulin 22 and the expansion arm are not affected by the tornado 5. The specially heavy-duty carrier 1 containing the expansion device is not involved inside the tornado 5 wind eye. The number of the expansion arm may also be greater than six. Such as eight expansion arms or sixteen expansion arms, etc. The expansion arms are symmetrically set. The more expansion arms are set, the higher stability of the blockage layer and isolation layer are formed. This can have the more significant blocking effect.

Based on the same idea, the release device 3 may also include the folded installation 31. The folded installation 31 is provided on the release device 3. The folded installation 31 includes the folded skeleton 311. The tarpaulin 22 is provided on the folded skeleton 311. The folded skeleton 311 can be opened or closed. After the folded skeleton 311 is opened, the outer diameter of the folded skeleton 311 is larger than the outer diameter of the tornado 5 wind eye. Based on the opening and closing of the folded skeleton 311, the tarpaulin 22 can be opened and closed. After the tarpaulin 22 is opened, it can form the blockage layer and the isolation layer. This is how destroy the vortex mechanism of the tornado 5.

The spraying device 4 includes the nozzle 41 and the stretching structure 42. The nozzle 41 is set on the stretching structure 42. The nozzle 41 of the spraying device 4 may be set as the shower type. The stretching structure 42 can adjust the spraying position and spraying direction of the nozzle 41. The stretching structure 42 can adjust the spraying position and spraying direction of the nozzle 41 by the hydraulically telescopic operation or the pneumatically telescopic operation. It can ensure that the spraying device 4 is always spraying spoiler 2 along the reverse direction of the tornado 5 vortex. It can ensure that the momentum of the spoiler 2 hedge, consume and weaken the cyclonic momentum of the tornado 5 vortex. The release device 3 and the spraying device 4 can be set on the same specially heavy-duty carrier 1. The specially heavy-duty carrier 1 can be set with the separate bin structure. One bin can be used to load the balloons 21 and other light material spoilers 2. The other bin can be used to load water liquid and so on. For example, when the specially heavy-duty carrier 1 moves to the tornado 5 wind eye, the release device 3 can release the balloons 21 and other light material spoiler 2 in the center of the tornado 5 wind eye. The spraying device 4 can adjust the nozzle 41 of the stretching structure 42 to the edge of the tornado 5 wind eye. It can adjust the spraying direction of the nozzle 41 to spray the water liquid. This does not need moving the specially heavy-duty carrier 1. The release device 3 and the spraying device 4 have the adjustable structure, respectively. It can achieve their adjustable functions. The release device 3 and the spraying device 4 can flexibly adjust the release position of the light spoiler 2 and the spraying position and direction of the water liquid. The specially heavy-duty carrier 1 can also be flexibly moved. It is not limited by the release position of the light spoiler 2, such as the ball. It is also not limited the spraying position and direction of the water liquid.

The device of combined cracking tornado 5 also includes: the dispensing device of the fog gun. The dispensing device of the fog gun is set on the specially heavy-duty carrier 1. The dispensing device of the fog gun is used to spray the spray adhesive and the light weight interstitial material 23, etc. The nozzle of the dispensing device of the fog gun can also be set into the shower type. It can make the spray adhesive and the light weight interstitial material 23 to become foggy and shower-like. Based on the same idea, the dispensing device of the fog gun has also the adjustment structure. The adjustment structure can make it have the adjustable function. For example, the dispensing device of the fog gun can adjust its nozzle 41 to the corresponding gap. Then it can spray and fill these spoilers 2. It can improve the effectiveness of the light weight interstitial material 23 to fill the gap. This will not be elaborated here.

The device of combined cracking tornado 5 also includes: the control module. The control module can connect with the release device 3 and control the work of the release device 3. The control module may achieve to control the release device 3 by the means of touch control. It can also achieve to control the release device 3 by the means of remote control. In this disclosure embodiment, the control module can connect with the expansion installation and the folded device 31. It can achieve the automation and intelligence of the adjustment of the release device 3. This is convenient and fast. This can improve the efficiency of cracking the tornado 5.

Based on the same idea, the device of combined cracking tornado 5 also includes: the multiple control modules. The multiple control modules can form the automated and intelligent control system. It can achieve the overall intelligent control of the device of combined cracking tornado. When it is cracking the tornado 5, the specially heavy-duty carrier 1 can be moved to the center of the tornado 5 wind eye by the remote control. The specially heavy-duty carrier 1 can move according to the movement of the tornado 5 wind eye. The work of cracking the tornado 5 is through to remotely control the release device 3, the spraying device 4 and the dispensing device of the fog gun, etc. The device of combined cracking tornado 5 does not need to be controlled by the operator. It can ensure the personal safety of the operator and improve the safety factor.

The method of combined cracking tornado and the device of combined cracking tornado can be set up in the zone of the national command centers and institutional systems for cracking tornadoes 5 and the countries and regions of the tornadoes 5 frequented. They can effectively crack the tornadoes 5 and protect the national personal safety and the national property safety.

Specifically, the disaster prevention agency is established. The establishment of the disaster prevention agency is based on the method of combined cracking tornado 5 in embodiments of the present disclosure. And the disaster prevention agency can be equipped with the device of combined cracking tornado 5 in embodiments of the present disclosure. For example, the formation of cracking tornado 5 can be formed. The formation of cracking tornado 5 can be equipped with the device of combined cracking tornado 5 of the present disclosure embodiment. The special operations team members of cracking the tornado can be provided some relevant training. The special operations team members of cracking the tornado can master the method of combined cracking tornado 5 and the device operation method of combined cracking tornado 5 by the present disclosure embodiment.

In this disclosed embodiment, the special operations team members of cracking the tornado can be set up each prone area of the tornado 5. And they can be mobilized and implemented by the disaster prevention agency. They can ensure that the work of the cracking tornadoes 5 is carried out in an orderly manner.

Each prone area of the tornado need strengthen and improve the tornado weather prediction system. This can achieve accurate prediction of the tornado for occurrence time, location and intensity information. It can achieve fast and timely warning to take the cracking tornado measures. This can avoid the tornado disasters. When the occurrence time, location and intensity information of the tornado is predicted, the warning system can feedback the information to the national command center. The national command center directs disaster prevention agencies to implement the measures of the cracking tornado. The disaster prevention agency receives the command order from the national command center. Based on the predicted information of the cracking tornado, the disaster prevention agency can orderly mobilize the special operations team members of cracking the tornado to implement the measures of the cracking tornado.

Thus, the zone of the national command centers and institutional systems for cracking tornadoes 5 and the countries and regions of the tornadoes 5 frequented can implement the measures to crack tornadoes 5 in an orderly and systematic manner. This can quickly and effectively avoid the weather disasters of the tornado 5.

In summary, according to the characteristic features, generation factors, cyclone structure, duration and survival conditions of the tornado, the present disclosure embodiment provides the method of combined cracking tornado and the device of combined cracking tornado. The spoilers 2, the release device 3 and the spraying device 4 are loaded on the specially heavy-duty carrier 1. The specially heavy-duty carrier 1 can improve the overall stability of the device of combined cracking tornado. The overall stability of the device is not affected by the tornado. And each of its devices can work properly. After the spoiler 2 can be released, the spoiler 2 can form a blockage body at the bottom of the tornado 5 wind eye. It can block the tornado 5 wind eye and block the convection system of the unstable energy in the atmosphere updraft. It can crack the tornado 5. The spraying device 4 can spray the spoiler 2 to the edge of the tornado 5 wind eye against the direction of the tornado 5 vortex. The momentum of the spoiler 2 can hedge, consume and weaken the cyclonic momentum of the tornado 5. Through the combined ways to achieve effectively and thoroughly crack the tornado 5. And each device of the present disclosure embodiment can be controlled by automation and intelligence. This can improve the safety factor of the controller to implement the control. It has a greater significance.

It is to be understood that the present disclosure is not limited to the precise structure of the above description and the accompanying drawings. The various modifications and changes may be made without departing from its scope. The scope of the present disclosure is limited only by the appended claims.

1. A method of combined cracking the tornado, the method comprising:
A is providing a specially heavy-duty carrier;
B is providing a spoiler, the spoiler is loaded on the specially heavy-duty carrier;
C is providing a release device, the release device is provided on the specially heavy-duty carrier, and when the specially heavy-duty carrier is moved to the tornado wind eye, the release device can release the spoiler, the spoiler is able to form the blockage body at the bottom of the tornado wind eye, the blockage body is able to block the tornado wind eye and crack the tornado wind;
D is providing the spray device, the spray device is set on the specially heavy-duty carrier, the spray device is moved to the edge of the tornado wind eye, the spray device can spray the spoiler along the reverse direction of the tornado vortex, the spoiler can hedge, consume and weaken the cyclonic momentum of the tornado and crack the tornado.

2. A method of combined cracking the tornado according to claim 1, wherein the spoiler includes the light weight material product, the release device can release the spoiler, the spoiler can form a light blockage body.

3. A method of combined cracking the tornado according to claim 1, wherein the spoiler includes the liquid, the liquid is sprayed by the spray device along the reverse direction of the tornado vortex, the momentum of the liquid can offset with the cyclonic momentum of the tornado and crack the tornado.

4. A method of combined cracking the tornado according to claim 2, wherein the spoiler includes a plurality of balloons, the balloons are pre-assembled in the specially heavy-duty carrier, the balloons are attached to the specially heavy-duty carrier, the release device can release the balloons, the balloons rapidly expand in the internal negative pressure state of the tornado wind eye and form a balloon blockage body.

5. A method of combined cracking the tornado according to claim 4, wherein the method also includes:
E is providing a spray adhesive;
F is providing the dispensing device of the fog gun, the dispensing device of the fog gun is set on the specially heavy-duty carrier, the spray adhesive is pre-installed within the dispensing device of the fog gun;
G is that the dispensing device of the fog gun sprays the spray adhesive onto the balloons; then a balloon and another balloon are bond each other.

6. A method of combined cracking the tornado according to claim 5, wherein the method also includes:
H is providing the light weight interstitial material, the light weight interstitial material is pre-installed within the dispensing device of the fog gun, the light weight interstitial material is used to fill the gap of the adjacent balloons.

7. A method of combined cracking the tornado according to claim 2, wherein the spoiler is the tarpaulin, the tarpaulin is pre-installed within the release device; the release device can open or close the tarpaulin, when the tarpaulin is opened, the outer diameter of the tarpaulin is greater than the outer diameter of the tornado wind eye.

8. A device of combined cracking the tornado, wherein the device comprises:
the specially heavy-duty carrier, the spoiler used to form a blockage body at the bottom of the eye of the tornado wind is loaded on the specially heavy-duty carrier;
the release device, the release device is provided on the specially heavy-duty carrier, the release device can release the spoiler;
the spraying device, the spraying device is provided on the specially heavy-duty carrier, the spraying device can spray the spoiler to hedge, consume and weaken the cyclonic momentum of the tornado and crack the tornado.

9. A device of combined cracking the tornado according to claim 8, wherein the device also comprises:
the dispensing device of the fog gun, the dispensing device of the fog gun is set on the specially heavy-duty carrier.

10. A device of combined cracking the tornado according to claim 8, wherein the release device includes the expansion installation and/or the folded installation;
the expansion installation is set on the release device, the expansion installation has the expansion arm, the expansion arm can stretch and contract around the expansion installation, after the expansion arm stretching, the outer diameter of the expansion arm is greater than the outer diameter of the tornado wind eye;
the folded installation is set on the release device, the folded installation includes the folded skeleton, the folded skeleton can stretch and contract, after the folded skeleton stretching, the outer diameter of the folded skeleton is greater than the outer diameter of the tornado wind eye.
